(19) United States
(12) Patent Application Publication
(10) Pub. No.: US 2019/0044163 A1
(43) Pub. Date: Feb. 7, 2019

(54) FUEL CELL AND ASSOCIATED HEATING SYSTEM

(71) Applicant: SAFRAN POWER UNITS, Toulouse (FR)

(72) Inventor: Antoine ROMET, Igoville (FR)

(73) Assignee: SAFRAN POWER UNITS, Toulouse (FR)

(21) Appl. No.: 16/075,171

(22) PCT Filed: Feb. 3, 2017
(86) PCT No.: PCT/FR2017/050245

§ 371 Date: Aug. 3, 2018

(30) Foreign Application Priority Data
Feb. 5, 2016 (FR) 1650948

(51) Int. Cl. H01M 8/0284; H01M 8/0267; H01M 8/04007; H01M 8/04225; H01M 8/04223; H01M 8/04302; H01M 8/04746; H01M 8/0432; H01M 8/04701

(52) U.S. Cl. CPC H01M 8/0284; H01M 8/0267; H01M 8/04037; H01M 8/04225; H01M 8/04567; H01M 8/04302; H01M 8/04753; H01M 8/04365; H01M 8/04731; H01M 8/04268

(57) ABSTRACT

A fuel cell including at least one sealing gasket (10), said sealing gasket (10) comprising a main body (12) and a heater member (14) having a heater element (16) and a power supply portion (18), the heater element (16) being embedded in the main body (12) and the power supply portion (18) being accessible from outside the main body (12).

### FIELD OF THE INVENTION

The present disclosure relates to a fuel cell, and more particularly to temperature regulation of a fuel cell.

### TECHNOLOGICAL BACKGROUND

A fuel cell, also referred to below as a “cell” or “FC”, comprises one or more cells arranged in a stack, each cell serving to react an oxidizing agent with a reducing agent in order to generate electricity.

A fuel cell generally has electrical efficiency that is considered to be low compared with the efficiency that can be obtained with other power sources. It is therefore important to maximize this efficiency by making the cell operate at an optimum temperature. Furthermore, with certain cells, operating below a certain temperature degrades cells irremediably.

It is therefore necessary to be able to take a fuel cell to its optimum operating temperature. This can require the fuel cell to be heated before it is started, in particular when the fuel cell is in a cold environment such as a space aircraft after launch.

For this purpose, it is known to heat a fluid upstream from the fuel cell, e.g. by means of a thermoplunger, and to cause the fluid to circulate through the cell in order to heat it. Nevertheless, such a system is penalizing in terms of weight and cost and its efficiency can be improved.

There therefore exists a need for a novel type of fuel cell.

### SUMMARY OF THE INVENTION

To this end, the present disclosure provides a fuel cell including at least one sealing gasket, said sealing gasket comprising a main body and a heater member having a heater element and a power supply portion, the heater element being embedded in the main body and the power supply portion being accessible from outside the main body.

When the fuel cell has a plurality of sealing gaskets, the above characteristics may relate to one of said gaskets, to a plurality of said gaskets, or indeed to each of said gaskets. Below, only one sealing gasket is described, it being understood that, unless mentioned to the contrary, the description that follows is applicable to a plurality of sealing gaskets, or to each of them.

Saying that the heater element is “embedded” in the main body means that the heater element is situated inside the main body, being completely surrounded by the main body. The heater element may be in contact with the material of the main body either directly or indirectly. Thus, when the sealing gasket is considered from the outside, the heater element cannot be seen and it is not directly accessible from outside the sealing gasket; nevertheless, the power supply portion can be seen and it is accessible from outside the sealing gasket, regardless of whether or not the power supply portion is a heater portion. Consequently, although the heater element is embedded in the main body, it can be powered by means of the power supply portion.

The sealing gasket may be integrated in the fuel cell at various locations, depending on the technology used for the fuel cell. It may provide sealing between the various fluids flowing through the fuel cell and/or sealing with the outside of the fuel cell. An example is described in detail below.

The inventors have observed that, because of their specifications that make them suitable for being used in a fuel cell, the materials that are conventionally used for sealing gaskets present very great temperature stability, very low thermal resistivity, and good qualities of adhesion with metals and polymers. These properties make a sealing gasket suitable for integrating a heater member. This enables the heating to be more efficient, since it is performed in situ, i.e. within the fuel cell. Also, integrating a heater member in the sealing gasket limits any increase in the cost or the weight of the fuel cell.

In some embodiments, the heater element comprises an electrical resistance. Heating thus takes place by the Joule effect and not by the flow of a fluid, thereby further simplifying the fuel cell and reducing its weight.

In some embodiments, the conductivity of the electrical resistance decreases with increasing temperature. In other words, in such embodiments, the electrical resistance increases progressively as temperature increases. It is also said that the resistance has a temperature coefficient that is positive, since the partial derivative of its resistivity relative to temperature is positive. Thus, for a given power supply voltage, the amount of heat dissipated by the Joule effect decreases progressively with increasing temperature. This has the effect of automatically and passively regulating the quantity of heat delivered as a function of the actual temperature of the fuel cell, or more precisely of the actual temperature of the sealing gasket. This avoids having recourse to a regulator device.

In some embodiments, the heater element comprises at least one electric wire, and preferably a network of electric wires. A network of electric wires is a set of wires connected in series and/or in parallel. A greater area can be covered with a network of wires than with a single wire. Thus, heating is more uniform and faster. Alternatively, or in addition, the heater element may comprise a fabric having an electrically conductive material deposited thereon.

In some embodiments, the main body is made of elastomer. Examples of suitable elastomers are blends comprising at least one of the following components: fluoropolymers, perfluoropolymers, neoprenes, nitriles, and polyurethanes. The main body may be configured to withstand the heat produced by the fuel cell after it has started.

In some embodiments, the sealing gasket includes at least one piece of reinforcement embedded in the main body. The reinforcement serves in particular to avoid the main body suffering creep, which may be caused by the rise in temperature, and which would lead to the heater element becoming visible from outside the main body. The reinforcement thus guarantees the integrity of the heater element.

The reinforcement may be reinforcement that is purely mechanical and/or reinforcement that is electrically insulating.

In some embodiments, the sealing gasket has two pieces of reinforcement embedded in the main body on either side of the heater element. In these embodiments, a particular function of the reinforcement is to provide electrical insulation.

The present disclosure also provides a heater system for heating a fuel cell as described above, the heater system comprising both an energy source configured to be connected to the power supply portion and configured to power the heater member, and also a regulator, the regulator being configured to control the energy source as a function of an estimate of the temperature of the sealing gasket. Such a heater system including a regulator is particularly useful when the heater member is not a member that is regulated automatically, such as a resistance with a positive temperature coefficient.

In some embodiments, the heater element comprises an electrical resistance, the energy source comprises an electricity source, and the regulator is configured to estimate the temperature of the sealing gasket as a function of an electrical characteristic of the resistance. The electrical characteristic may be selected from resistance, conductance, current, voltage, or any electrical magnitude calculated therefrom.

The regulator may be implemented in the form of a computer executing the instructions of a program. Consequently, the present disclosure also provides a program and a data medium, the program being suitable for being performed in a regulator, or more generally in a computer, the program including instructions adapted to providing a regulator that is configured as above.

The program may use any programming language, and it may be in the form of source code, object code, or code intermediate between source code and object code, such as in a partially compiled form, or in any other desirable form.

The present disclosure also provides a data medium that is readable by a computer or by a microprocessor and that includes instructions of a program as mentioned above.

The data medium may be any entity or device capable of storing the program. For example, the medium may comprise storage means, such as a read-only memory (ROM), for example a compact disk (CD) ROM, or a microelectronic circuit ROM, or indeed magnetic recording means, e.g. a floppy disk or a hard disk.

Furthermore, the data medium may be a transmissible medium such as an electrical or optical signal that can be conveyed via an electrical or optical cable, by radio, or by other means. The program of the invention may in particular be downloaded from a network of the Internet type.

The present disclosure also provides an assembly comprising a fuel cell and a heater system as described above for heating said fuel cell.

The present disclosure also provides a method of putting into operation a fuel cell as described above, wherein:

so long as the temperature of the fuel cell is strictly less than a starting temperature, the heater member is actuated, with the flow of fluids through the fuel cell being interrupted; and

when the temperature of the fuel cell is greater than or equal to the starting temperature, the fuel cell is started.

The flow of fluids being interrupted refers both to the flow of reagents and to the flow of the cooling fluid or, if applicable, of a fluid that is hotter than the fuel cell and that is for heating it.

Depending on its nature and how it is regulated, the heater member may optionally be switched off when the fuel cell starts or reaches its starting temperature.

The temperature of the fuel cell may be measured at a representative point or it may be the mean of temperatures measured at a plurality of points in the fuel cell.

### BRIEF DESCRIPTION OF THE DRAWINGS

The invention and its advantages can be better understood on reading the following detailed description of embodiments of the invention given as non-limiting examples. The description refers to the accompanying drawings, in which:

FIG. 1 is a diagrammatic exploded view of a fuel cell in a first embodiment;

FIG. 2 is a section view of a sealing gasket as used in the FIG. 1 fuel cell;

FIG. 3 is a diagrammatic exploded view showing the structure of the FIG. 2 sealing gasket in an embodiment;

FIG. 4 is a diagrammatic exploded view of the structure of the FIG. 2 sealing gasket in another embodiment; and

FIG. 5 is a diagrammatic view of a system for heating a fuel cell.

### DETAILED DESCRIPTION OF THE INVENTION

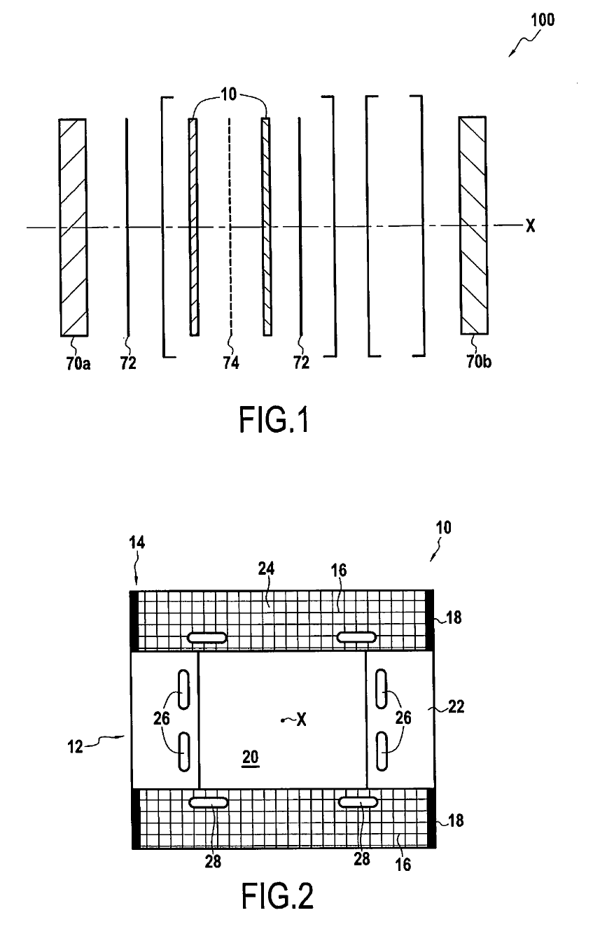

FIG. 1 is a diagrammatic exploded view of a fuel cell 100 in a first embodiment. In this embodiment, the fuel cell is of the proton-exchange membrane type. Such a fuel cell comprises two outer plates 70a and 70b with cells stacked between them in a stacking direction X. In order (from left to right in FIG. 1), each cell comprises: a first bipolar plate 72; a gasket 10; an electroactive membrane 74; another gasket 10; and a second bipolar plate 72. The sealing gaskets 10 are used in particular for separating and providing sealing between the bipolar plate 72 and the electroactive membrane 74. The role of the bipolar plate 72 is to distribute the reagent, and where appropriate, the cooling fluid that cools the cell once said cell has reached its nominal operating condition. The electroactive membranes 74, or proton-exchange membranes, serve to block the passage of electrons while allowing protons to pass through. Thus, electrons are constrained to pass via an electrical circuit that is external to the stack of cells. The reagents are generally oxygen, e.g. in the form of air containing dioxygen, and hydrogen, e.g. in the form of gaseous dihydrogen.

The layers situated between square brackets in FIG. 10, i.e. in order (from left to right in FIG. 1): a gasket 10; an electroactive membrane 74; another gasket 10; and a bipolar plate 72, may be repeated in that order as often as desired in order to increase the number of cells and thus the power of the stack of cells 100.

FIG. 2 is a detailed section view of one of the sealing gaskets 10. In the present embodiment, all of the sealing gaskets 10 are identical, however they need not necessarily be identical.

As mentioned above, the sealing gasket 10 comprises a main body 12. In this example the main body 12 is made of elastomer. By way of example, the main body 12 presents a generally rectangular shape in which an opening 20 is provided. The opening 20 forms a duct making it easier to make temperature uniform within the fuel cell 100 and enabling chemical species to migrate towards the electroactive membrane 74.

Furthermore, the sealing gasket 10 includes a heater member 14. The heater member 14 itself comprises a heater element 16 and a power supply portion 18. In this example the heater element 16 is in the form of a network of electric wires, typically having a diameter of about one-tenth of a millimeter. Said electric wires have non-zero resistance, thereby forming an electrical resistance element. Within the network, the wires may be connected to one another in series, in parallel, or in any other possible arrangement.

In the present embodiment, a plurality of wires are connected in parallel between two terminals forming the power supply portion 18. This plurality of wires may be obtained from a fabric comprising an array of parallel wires, and from which a shape is cut out, e.g. by a punch or a laser, which shape is suitable for being inserted in the main body 12 of the sealing gasket 10.

In this example, in order to simplify connection, said appropriate shape is such that first opposite lateral portions 22 of the main body 12 do not have electric wires. Second opposite lateral portions 24 of the main body 12 are provided with electric wires.

Alternatively, wires may extend over the first and second opposite lateral portions 22 and 24. This makes the sealing gasket 10 even easier to fabricate. Under such circumstances, the wires situated in the first opposite lateral portions 22 need not be powered.

Also alternatively, the heater element 16 may be constituted by a single wire arranged within the main body 12.

Also alternatively, the heater member 14 may include a substrate, e.g. made of elastomer, having a conductive metal layer deposited thereon to form the heater element 16.

Also alternatively, the heater member 14 may comprise conductive fabric, itself comprising a heater element 16 such as carbon fibers. An example of such a fabric is Thermion (registered trademark) fabric sold by the American supplier Thermion Systems International, Inc.

For a single wire or a network of wires, the wire(s) may run along one or more sides, e.g. following a sinuous or zigzag path.

As mentioned above, the heater element 16 is embedded in the main body 12, while the power supply portion 18 is accessible from outside the main body 12. Thus, although the heater element 16 is embedded in the main body 12, it is possible to power it (electrically in this example) by means of the power supply portion 18. When the heater element 16 comprises an electrical resistance, the sealing gasket 10 may have at least two power supply portions 18 corresponding to two electrical terminals.

The sealing gasket 10 also has ducts 26, 28 for passing the respective reagents of the fuel cell 100 and for passing the cooling fluid. By way of example, among the eight ducts 26, 28 shown in FIG. 2, four may be for passing reagents and four may be for passing the cooling fluid. The dimensions of these ducts 26, 28 may differ depending on their function. For example, ducts for passing cooling fluid may be smaller in section than ducts for passing reagents.

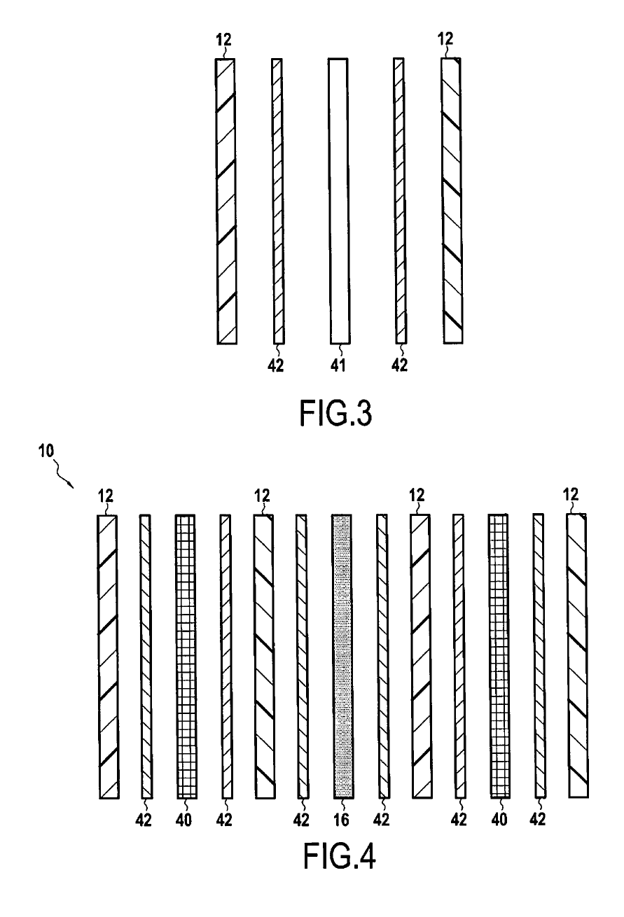

FIGS. 3 and 4 are diagrammatic exploded views showing the structure of the FIG. 2 sealing gasket. In these embodiments, the sealing gasket 10 includes at least one piece of reinforcement 40 embedded in the main body 12.

In an embodiment shown in FIG. 3, the piece of reinforcement 40 is an integral portion of an industrial fabric 41 that also includes the heater element 16, e.g. in the form of an electric grid, of conductive fibers, or in any of the forms descried above. Layers of binder 42 are provided between the industrial fabric 41 and the main body 12 within the main body 12. The binder 42, also referred to as “cement”, may comprise elastomer together with a solvent of acetone type.

In another embodiment shown in FIG. 4, the sealing gasket 10 has two pieces of reinforcement 40 situated on either side of the heater element 16.

A portion of the main body 12 lies between the reinforcement 40 and the heater element 16. In this example, said portion of the main body 12 keeps the reinforcement 40 separate from the heater element 16. In addition, layers of binder 42 may be provided between the heater element 16 and the main body 12, and/or between the reinforcement 40 and the main body 12, in order to reinforce the retention of the heater element 16 and/or of the reinforcement 40, respectively, inside the main body.

In this example, the reinforcement 40 may be provided in the form of a fabric, in particular an almost transparent fabric of thickness that is of the order of a fraction of a millimeter (a few hundreds of micrometers) and of density of the order of one gram per square meter. Thus, the reinforcement 40 has negligible impact on the thermal properties of the main body 12. In contrast, the reinforcement 40 reinforces the ability of the main body to withstand creep and prevents any contact between the heater element 16 (made of metal in this example) and the bipolar plates 72, thus avoiding the appearance of short circuits within the fuel cell 100.

Such fabrics are themselves known. By way of example, such reinforcement 40 may be made of polyamide.

As mentioned above, the electrical resistance of the heater element 16 may be provided by a material of conductivity that decreases with increasing temperature. Such materials, for which the partial derivative of resistance relative to temperature is positive, may for example be ceramic, in particular ceramics including BaTiO₃ or constituted mainly, or indeed exclusively, by BaTiO₃. Thus, when the temperature of the fuel cell 100 increases, the Joule effect losses in the heater element 16 decrease for constant electrical power supply. It is possible to design the electrical resistance, e.g. by varying the length and the section of the electric wires, in a manner that is appropriate to ensure that the Joule effect losses become negligible, typically of the order of a few watts, once the fuel cell reaches a temperature that is suitable for starting the fuel cell.

It is also possible to use an electrical resistance having a negative temperature coefficient. Under such circumstances, regulation is needed to regulate the energy dissipated by the Joule effect in the heater element 16. Such regulation may also be used with a resistance having a positive heater element coefficient.

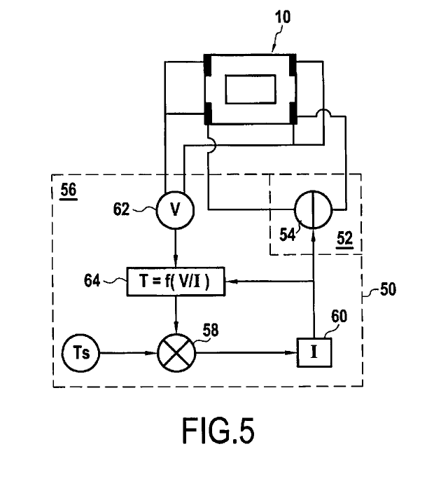

For this purpose, FIG. 5 shows a heater system 50 for a fuel cell such as the fuel cell 100. The fuel cell 100 and a single sealing gasket 10 are shown in simplified manner. As mentioned above, the heater system 50 includes an energy source 52 connected to the power supply portion 18 and configured to power the heater member 14. In this example, the energy source 52 is an electricity source 54. The electricity source 54 is connected to the power supply portions 18 so as to power the heater member 14, and more particularly the heater element 16, in such a manner that the heater element 16 gives off heat. The electricity source 54 may be a voltage generator.

Furthermore, the heater system 50 includes a regulator 56 configured to control the energy source 52 as a function of an estimate of the temperature T of the sealing gasket 10. For example, the regulator 56 can reduce the power delivered by the energy source 52 progressively as the temperature increases. Alternatively, or in addition, the regulator 56 may stop the energy source 52 when the estimated temperature T reaches a starting temperature Ts for the fuel cell 100, and/or it may start the energy source 52 when the fuel cell 100 is to be started and the estimated temperature T is lower than the starting temperature Ts.

For a fuel cell of the type of the present embodiment, the temperature Ts may be about 200° C.

In this example, the regulator 56 is configured to estimate the temperature T of the sealing gasket 10 as a function of an electrical characteristic of the resistance.

More precisely, in this embodiment, the regulator 56 includes measurement means 62 configured to measure an electrical characteristic of the resistance. In this example, the electrical characteristic is the voltage V across the terminals of the resistance, i.e. between the two power supply portions 18, for example. The measurement means 62 may be omitted when the electrical characteristic can be obtained by other means; for example, specifically, the voltage V between the two power supply portions 18 corresponds to the power supply voltage of the electricity source 54 and it may be accessible more simply as such.

The regulator 56 also includes estimator means 64 configured to estimate the temperature T of the sealing gasket 10 from the electrical characteristic measured by the measurement means 62. In this case, since the power supply current I of the heater member 14 and the voltage V across the terminals of the heater member 14 are known, the temperature T is determined as being equal to f(V/I), where V/I is the resistance of the heater member 14 and f is the function that is the reciprocal of the function giving resistance as a function of the temperature for the heater member 14. The function f may be calculated analytically, it may be calculated digitally, or it may be estimated empirically by means known to the person skilled in the art.

Thereafter, a comparator 58 compares the estimated temperature T with the starting temperature Ts, which is predetermined as a function of the characteristics of the fuel cell 100. A control device 60 then adapts the current I as a function of a predetermined control relationship, e.g. as mentioned above. The control value for the current I is delivered to the estimator device in order to calculate the estimated temperature T. The control value of the current I is supplied to the energy source 52, which in turn powers the heater member 14 with said current.

Regardless of whether the heater element 16 has resistance with a thermal coefficient that is positive or negative, it is possible to perform the following method for heating the fuel cell:

so long as the temperature T of the fuel cell 100 is less than the starting temperature Ts, the heater member 14 is actuated, while fluid flow through the fuel cell 100 is interrupted; and

when the temperature T of the fuel cell 100 reaches the starting temperature Ts, the fuel cell 100 is started.

The reaction that takes place in the fuel cell is exothermic, so once the fuel cell has started, its temperature increases naturally. There is then no longer any need to use the heater member 12 for heating the fuel cell 100. The heater member 12 can thus be deactivated.

Insofar as the flow of fluids, in particular of the reagents and of the cooling fluid, is interrupted so long as the temperature of the fuel cell 100 is below the starting temperature Ts, it is reasonable to assume that the temperature within the fuel cell is uniform. If, as in the present embodiment, the sealing gaskets 10 are all identical, then the heating of the fuel cell 100 by the respective heater members 14 is uniform in three dimensions. Consequently, the temperature of the fuel cell can be approximated, without much loss of accuracy, as being equal to the temperature of any arbitrarily selected sealing gasket 10. The temperature of such a sealing gasket 10 can be estimated as described above, on the basis of an electrical characteristic.

Although the present invention is described with reference to specific embodiments, modifications may be made to those embodiments without going beyond the general ambit of the invention as defined by the claims. In particular, individual characteristics of the various embodiments shown and/or mentioned may be combined in additional embodiments. Consequently, the description and the drawings should be considered in a sense that is illustrative rather than restrictive.

1. A fuel cell including at least one sealing gasket, said sealing gasket comprising a main body and a heater member having a heater element and a power supply portion, the heater element being embedded in the main body and the power supply portion being accessible from outside the main body.

2. The fuel cell according to claim 1, wherein the heater element comprises an electrical resistance.

3. The fuel cell according to claim 2, wherein the conductivity of the electrical resistance decreases with increasing temperature.

4. The fuel cell according to claim 1, wherein the heater element comprises at least one electric wire, preferably a network of electric wires.

5. The fuel cell according to claim 1, the main body being made of elastomer.

6. The fuel cell according to claim 1, wherein the sealing gasket includes at least one piece of reinforcement embedded in the main body.

7. A heater system for heating the fuel cell according to claim 1, the heater system comprising both an energy source configured to be connected to the power supply portion and configured to power the heater member, and also a regulator, the regulator being configured to control the energy source as a function of an estimate of the temperature of the sealing gasket.

8. The heater system according to claim 7, wherein the heater element comprises an electrical resistance, the energy source comprises an electricity source, and the regulator is configured to estimate the temperature of the sealing gasket as a function of an electrical characteristic of the resistance.

9. An assembly comprising a fuel cell and the heater system according to claim 7 for heating said fuel cell.

10. A method of putting into operation the fuel cell according to claim 1, wherein comprising: actuating the heater member with the flow of fluids through the fuel cell being interrupted, so long as the temperature of the fuel cell is strictly less than a starting temperature; and
starting the fuel cell when the temperature of the fuel cell is greater than or equal to the starting temperature.
